(19) United States
(12) Patent Application Publication
(10) Pub. No.: US 2016/0245356 A1
(43) Pub. Date: Aug. 25, 2016

(54) MULTI-INSULATED INSULATOR AND MANUFACTURING METHOD THEREOF

(71) Applicant: Hyundai Motor Company, Seoul (KR)

(72) Inventor: Gi-Bong JO, Seoul (KR)

(73) Assignee: Hyundai Motor Company, Seoul (KR)

(21) Appl. No.: 14/826,424

(22) Filed: Aug. 14, 2015

(30) Foreign Application Priority Data
Feb. 24, 2015 (KR) 10-2015-0025812

(51) Int. Cl. F16F 1/38

(52) U.S. Cl. CPC F16F 1/38; F16F 1/3856

(57) ABSTRACT

A core bush of a multi-insulated insulator may include a cylinder-shaped core upper plate of which a bottom surface is formed with a core upper plate hole at the center thereof, a bumper stopper cup of which a cylinder-shaped contact portion contacted with the core upper plate is formed to be projected on an upper surface thereof, a bush outer steel of a cylindrical shape opened at upper and lower portions thereof, and disposed to surround outer circumference surfaces of the core upper plate and the contact portion, and a rubber bush disposed between the outer circumference surfaces of the core upper plate and the contact portion and an inner circumference surface of the bush outer steel to couple the core upper plate and the contact portion to the bush outer steel.

### CROSS-REFERENCE TO RELATED APPLICATION

The present application claims priority to Korean Patent Application No. 10-2015-0025812, filed Feb. 24, 2015, the entire contents of which is incorporated herein for all purposes by this reference.

### BACKGROUND OF THE INVENTION

1. Field of the Invention

The present invention relates to a multi-insulated insulator and manufacturing method thereof, and more particularly, to a multi-insulated insulator and manufacturing method thereof capable of preventing friction noise between a core upper plate and a rubber bush from being generated.

2. Description of Related Art

FIG. 1 is a cross-sectional view of an insulation insulator according to the prior art. FIG. 2 is a diagram explaining the problems of the insulation insulator according to the prior art shown in FIG. 1. In the insulation insulator according to the prior art shown in FIG. 1 and FIG. 2, when a shock absorber is operated, a piston rod is rotated around rotating axis A, whereas a bumper stopper is fixed not to be rotated. Accordingly, there is disadvantage in that friction noise between the piston rod and the bumper stopper is generated. In order to prevent this, the prior art shown in FIG. 3 and FIG. 4 has been developed.

FIG. 3 is a cross-sectional view of an insulation insulator according to another prior art. FIG. 4 is a diagram explaining the problems of the insulation insulator according to another prior art shown in FIG. 3. In the insulation insulator according to another prior art shown in FIG. 3 and FIG. 4, the piston rod and a bumper stopper cup are fixedly connected with each other such that the bumper stopper is rotated together when the piston rod rotates. According to this, a constant gap between the piston rod and the bumper stopper is always maintained so that friction noise may not be generated.

The manufacturing method of the insulation insulator according to another prior art shown in FIG. 3 and FIG. 4 is to preferentially vulcanize a rubber bush between an insulator outer member and a bumper stopper cup. At this time, the rubber bush should be vulcanized in order for the inner diameter thereof to be smaller than the outer diameter of the core upper plate. Thereafter, it press-fits the core upper plate into the rubber bush and then combines the combining portions of the core upper plate and the bumper stopper cup through caulking. The rubber bush generates swaging effect when press-fitting the core upper plate into the rubber bush.

In the insulation insulator according to another prior art shown in FIG. 3 and FIG. 4, and manufactured by the manufacturing method as described above, the bumper stopper cup is bonded to the rubber bush through vulcanization but the core upper plate is simply press-fitted into the rubber bush. Accordingly, there was disadvantage that the more the swaging effect of the rubber bush was reduced depending on the progress of the vehicle endurance, friction noise between the rubber bush and core upper plate was generated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a multi-insulated insulator and manufacturing method thereof in which an insulator core bush and an insulator outer member are produced separately and then the insulator core bush is press-fitted into the insulator outer member.

According to various aspects of the present invention, a core bush of a multi-insulated insulator may include a cylinder-shaped core upper plate of which a bottom surface is formed with a core upper plate hole at the center thereof, a bumper stopper cup of which a cylinder-shaped contact portion contacted with the core upper plate is formed to be projected on an upper surface thereof, a bush outer steel of a cylindrical shape opened at upper and lower portions thereof, and disposed to surround outer circumference surfaces of the core upper plate and the contact portion, and a rubber bush disposed between the outer circumference surfaces of the core upper plate and the contact portion and an inner circumference surface of the bush outer steel to couple the core upper plate and the contact portion to the bush outer steel.

The contact portion may include a through-hole at an upper surface to be communicated with the core upper plate hole, and a coupling portion projected upward from an inner circumference surface of the through-hole to be inserted into the core upper plate hole.

A multi-insulated insulator may include the core bush of the multi-insulated insulator described above, and an insulator outer member formed to be contacted with an outer circumference surface of the bush outer steel of the core bush of the multi-insulated insulator for the core bush of the multi-insulated insulator to be press-fitted into.

According to various aspects of the present invention, a manufacturing method of a multi-insulated insulator, comprising may include manufacturing a core bush of a multi-insulated insulator by coupling a core upper plate with a contact portion of a bumper stopper cup, disposing a bush outer steel to surround an outer circumference surface of the core upper plate and an outer circumference surface of the contact portion, and bonding the core upper plate and the contact portion to the bush outer steel through vulcanization of a rubber bush, and coupling the core bush of the multi-insulated insulator with an insulator outer member by press-fitting the core bush of the multi-insulated insulator into the insulator outer member.

The coupling the core bush with the insulator outer member may couple the core upper plate and the coupling portion of the bumper stopper cup through caulking.

The manufacturing method of the multi-insulated insulator may further include processing the core upper plate in order to prevent separation of the core bush of the multi-insulated insulator from the insulator outer member after the coupling.

The processing the core upper plate may process the core upper plate through burring working.

The processing the core upper plate may process the core upper plate through press working.

According to the present invention as described above, a piston rod and the insulator core bush are fixedly connected with each other, thereby preventing the friction noise between the piston rod and the core bush of the insulator from being generated. The core upper plate and the rubber bush are bonded with each other through vulcanization, thereby preventing the friction noise between the core upper plate and the rubber bush from being generated and thus increasing the durability compared to the prior art.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an insulation insulator according to the prior art.

FIG. 2 is a diagram illustrating the problems of the insulation insulator according to the prior art shown in FIG. 1.

FIG. 3 is a cross-sectional view of an insulation insulator according to another prior art.

FIG. 4 is a diagram illustrating the problems of the insulation insulator according to the prior art shown in FIG. 3.

FIG. 5 is a cross-sectional view of a core bush of an exemplary multi-insulated insulator according to the present invention.

FIG. 6 is a cross-sectional view of an exemplary multi-insulated insulator according to the present invention.

FIG. 7 is a flow chart of a manufacturing method of a core bush of the exemplary multi-insulated insulator according to the present invention.

FIG. 8 is a flow chart of a manufacturing method of the exemplary multi-insulated insulator according to the present invention.

FIG. 9 and FIG. 10 are figures illustrating an exemplary manufacturing method of the multi-insulated insulator according to the present invention.

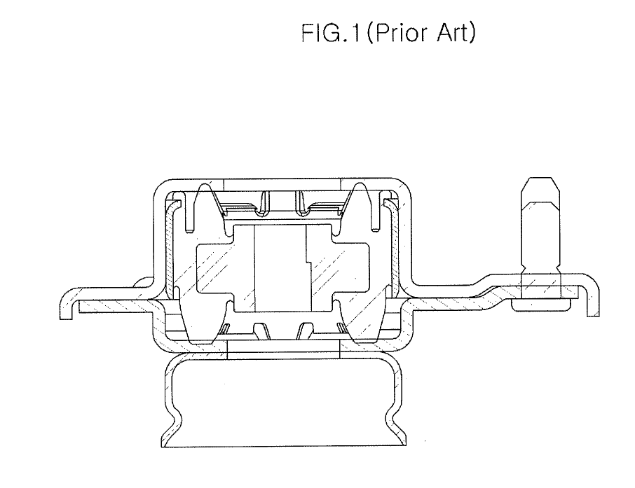

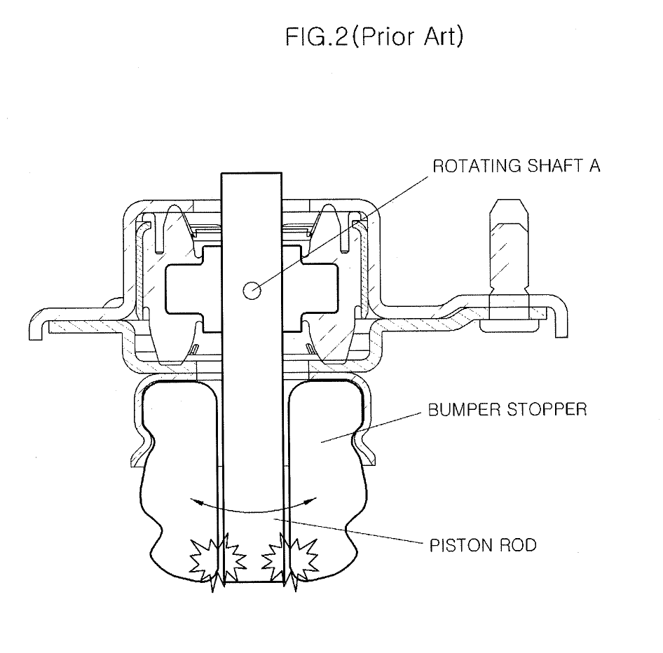

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

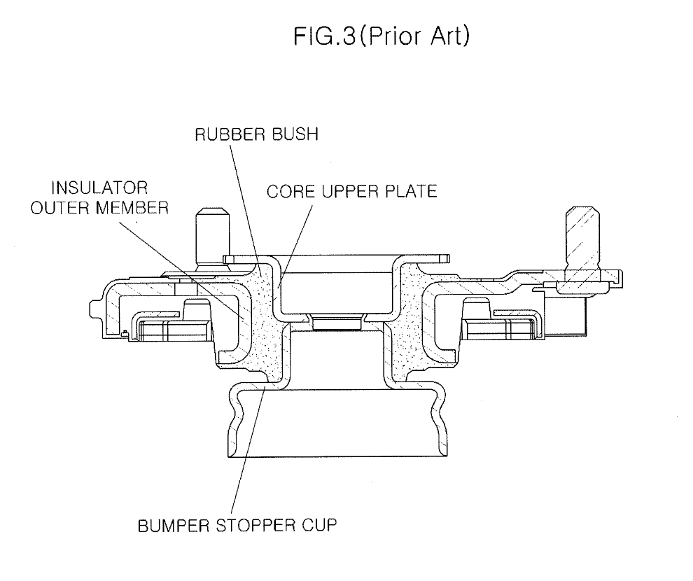

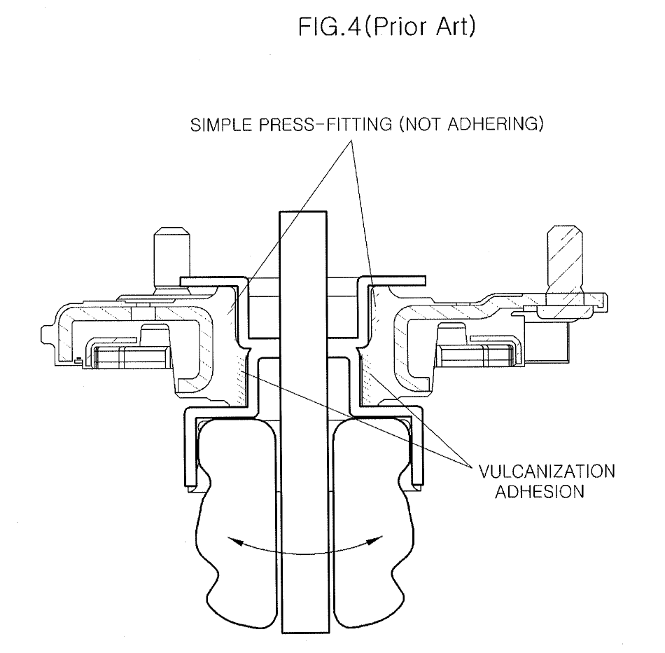

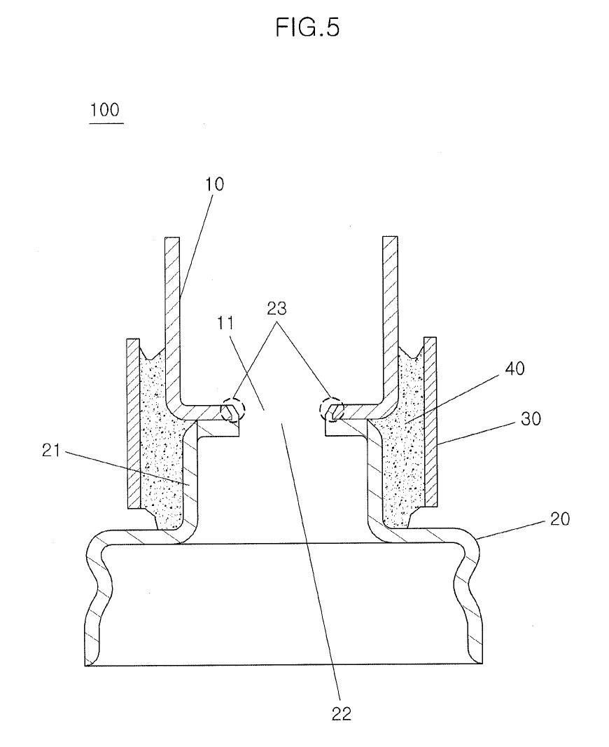

FIG. 5 is a cross-sectional view of a core bush 100 of a multi-insulated insulator according to various embodiments of the present invention. Referring to FIG. 5, the core bush of the multi-insulated insulator according to various embodiments of the present invention may include a cylinder-shaped core upper plate 10 of which a bottom surface is formed with a core upper plate hole 11 at the center thereof, a bumper stopper cup 20 of which a cylinder-shaped contact portion 21 contacted with the core upper plate 10 is formed to be projected on an upper surface thereof, a bush outer steel 30 of a cylindrical shape opened at upper and lower portions and disposed to surround outer circumference surfaces of the core upper plate 10 and the contact portion 21, and a rubber bush 40 disposed between the outer circumference surfaces of the core upper plate 10 and the contact portion 21 and an inner circumference surface of the bush outer steel 30 to bond the core upper plate 10 and the contact portion 21 to the bush outer steel 30. The rubber bush 40 may bond the core upper plate 10 and the contact portion 21 to the bush outer steel 30 through vulcanization. Accordingly, in the prior art shown FIG. 3 and FIG. 4 in which the core upper plate is simply press-fitted into the rubber bush such that friction noise between the rubber bush and the core upper plate was generated depending on the progress of the vehicle endurance, whereas in the present invention, the core upper plate 10 and the rubber bush 40 are bonded with each other through vulcanization, thereby preventing friction noise between the core upper plate 10 and the rubber bush 40 from being generated.

The contact portion 21 may include a through-hole 22 at an upper surface to be communicated with the core upper plate hole 11, and a coupling portion 23 projected upward from an inner circumference surface of the through-hole 22 to be inserted into the core upper plate hole 11. The coupling portion 23 and the core upper plate 10 may be coupled with each other by caulking. A piston rod is inserted into the through-hole 22 to be fixed, and a bumper stopper press-fitted into the bumper stopper cup 20 rotates together when the piston rod rotates. Accordingly, a constant gap between the piston rod and the bumper stopper is always maintained, whereby friction noise is not generated.

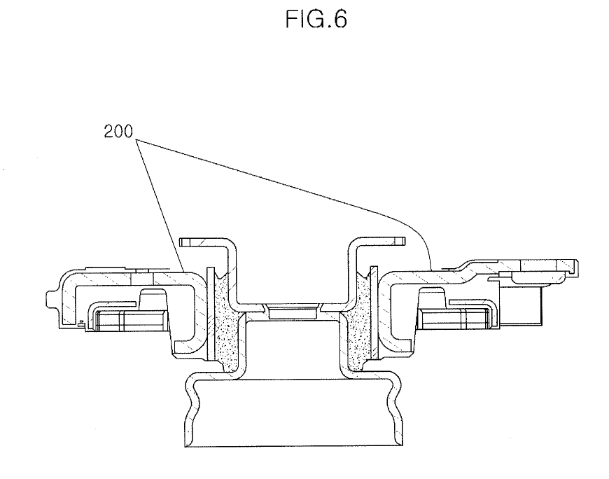

FIG. 6 is a cross-sectional view of a multi-insulated insulator according to various embodiments of the present invention. Referring to FIG. 6, the multi-insulated insulator according to various embodiments of the present invention may include the core bush 100 of the multi-insulated insulator and an insulator outer member 200 into which the outer circumference surface of the bush outer steel 30 of the core bush 100 of the multi-insulated insulator is contacted and press-fitted.

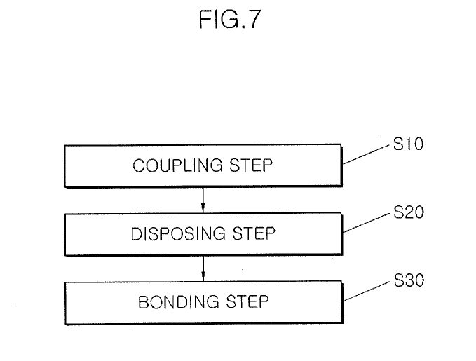

FIG. 7 is a flow chart of manufacturing method of the core bush of the multi-insulated insulator according to various embodiments of the present invention. Referring to FIG. 7, the manufacturing method of the core bush of the multi-insulated insulator according to various embodiments of the present invention may include the steps of coupling the core upper plate 10 with the contact portion 21 of the bumper stopper cup 20 (S10), disposing the bush outer steel 30 to surround the outer circumference surface of the core upper plate 10 and the outer circumference surface of the contact portion 21 (S20), and bonding the core upper plate 10 and the contact portion 21 to the bush outer steel 30 through vulcanization of the rubber bush 40 (S30).

The step of coupling (S10) features coupling the core upper plate 10 and the coupling portion 23 of the bumper stopper cup 20 by caulking. The caulking means working of eliminating the gap by cutting joints and edges of plate with stubby chisel in order to maintain air tightness.

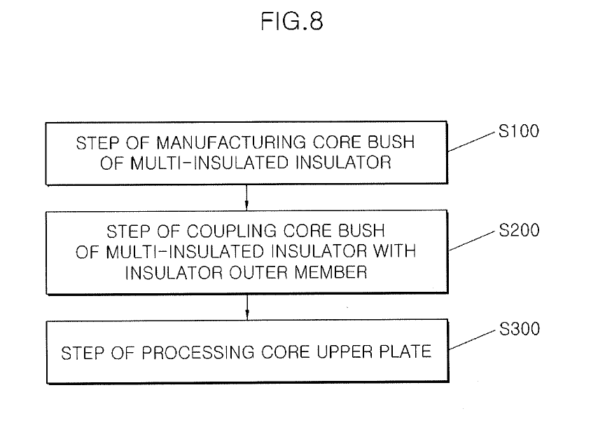

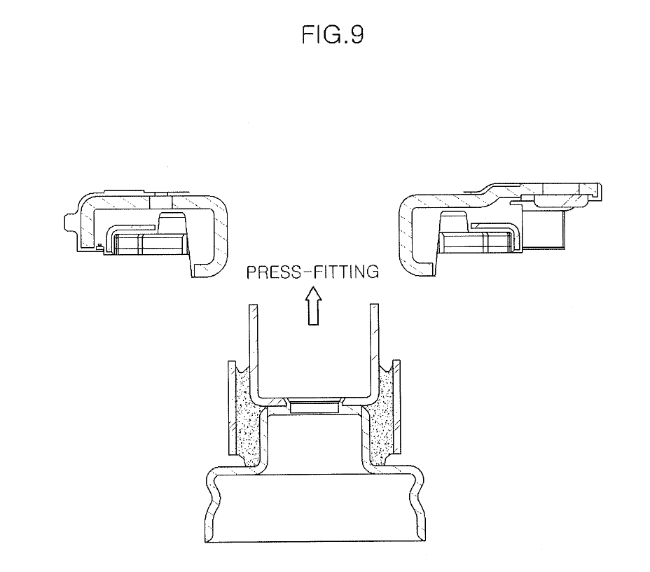

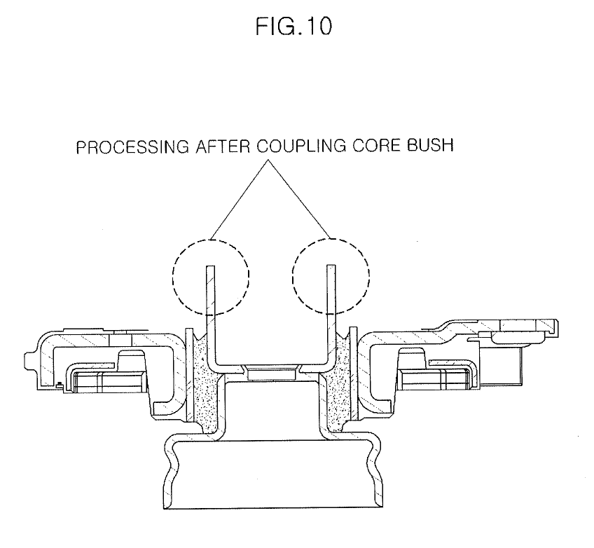

FIG. 8 is a flow chart of a manufacturing method of the multi-insulated insulator according to various embodiments of the present invention. FIG. 9 and FIG. 10 are figures illustrating a manufacturing method of the multi-insulated insulator according to various embodiments of the present invention. Referring to FIG. 7, and FIG. 8 to FIG. 10, the manufacturing method of the multi-insulated insulator according to various embodiments of the present invention may include the steps of manufacturing the core bush 100 of the multi-insulated insulator (as illustrated in FIG. 7) by coupling the core upper plate 10 with the contact portion 21 of the bumper stopper cup 20 (S10), disposing the bush outer steel 30 to surround the outer circumference surface of the core upper plate 10 and the outer circumference surface of the contact portion 21 (S20), and bonding the core upper plate 10 and the contact portion 21 to the bush outer steel 30 through vulcanization of the rubber bush 40 (S30) (S100), and coupling the core bush 100 of the multi-insulated insulator with the insulator outer member 200 by press-fitting the core bush 100 of the multi-insulated insulator into the insulator outer member 200 (S200) (refer to FIG. 9).

The manufacturing method of the multi-insulated insulator may further include a step of processing the core upper plate 10 in order for the core bush 100 of the multi-insulated insulator not to be separated from the insulator outer member 200 after the coupling step (S200) (S300).

The processing step (S300) features processing the core upper plate 10 through burring working or press working (refer to FIG. 10). Formed is the structure of preventing the core bush 100 of the multi-insulated insulator from being separated from the insulator outer member 200 by processing the core upper plate 10.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A core bush of a multi-insulated insulator, comprising:
a cylinder-shaped core upper plate of which a bottom surface is formed with a core upper plate hole at the center thereof;
a bumper stopper cup of which a cylinder-shaped contact portion contacted with the core upper plate is formed to be projected on an upper surface thereof;
a bush outer steel of a cylindrical shape opened at upper and lower portions thereof, and disposed to surround outer circumference surfaces of the core upper plate and the contact portion; and
a rubber bush disposed between the outer circumference surfaces of the core upper plate and the contact portion and an inner circumference surface of the bush outer steel to couple the core upper plate and the contact portion to the bush outer steel.

2. The core bush of the multi-insulated insulator of claim 1, wherein the contact portion comprises:
a through-hole at an upper surface to be communicated with the core upper plate hole; and
a coupling portion projected upward from an inner circumference surface of the through-hole to be inserted into the core upper plate hole.

3. A multi-insulated insulator, comprising:
the core bush of the multi-insulated insulator of claim 1; and
an insulator outer member formed to be contacted with an outer circumference surface of the bush outer steel of the core bush of the multi-insulated insulator for the core bush of the multi-insulated insulator to be press-fitted into.

4. A manufacturing method of a multi-insulated insulator, comprising:
manufacturing a core bush of a multi-insulated insulator by coupling a core upper plate with a contact portion of a bumper stopper cup;
disposing a bush outer steel to surround an outer circumference surface of the core upper plate and an outer circumference surface of the contact portion; and
bonding the core upper plate and the contact portion to the bush outer steel through vulcanization of a rubber bush; and
coupling the core bush of the multi-insulated insulator with an insulator outer member by press-fitting the core bush of the multi-insulated insulator into the insulator outer member.

5. The manufacturing method of the multi-insulated insulator of claim 4, wherein the coupling the core bush with the insulator outer member couples the core upper plate and the coupling portion of the bumper stopper cup through caulking.

6. The manufacturing method of the multi-insulated insulator of claim 4, further comprising:
processing the core upper plate in order to prevent separation of the core bush of the multi-insulated insulator from the insulator outer member after the coupling.

7. The manufacturing method of the multi-insulated insulator of claim 6, wherein the processing the core upper plate processes the core upper plate through burring working.

8. The manufacturing method of the multi-insulated insulator of claim 6, wherein the processing the core upper plate processes the core upper plate through press working.
